(19) United States
(12) Patent Application Publication
(10) Pub. No.: US 2011/0258350 A1
(43) Pub. Date: Oct. 20, 2011

(54) APPARATUS AND METHOD FOR SUPPORTING EXTERNAL MEMORIES IN PORTABLE TERMINAL

(75) Inventor: Hyun-Woo KIM, Suwon-si (KR)

(73) Assignee: SAMSUNG ELECTRONICS CO. LTD., Suwon-si (KR)

(21) Appl. No.: 13/085,930

(22) Filed: Apr. 13, 2011

(30) Foreign Application Priority Data
Apr. 20, 2010 (KR) 10-2010-0036293

(51) Int. Cl. G06F 3/00

(52) U.S. Cl. 710/51

(57) ABSTRACT

An apparatus and method for supporting a plurality of external memories in a portable terminal are provided. The apparatus includes a first memory mounted in a first memory slot, a second memory mounted in a second memory slot, a control unit for creating a list of data items stored in at least one of the external memories and for outputting a command for selecting one of the external memories, and a switching unit for determining and selecting one of the external memories storing next data to reproduce during the reproduction of data included in the list, wherein the switching unit includes a multiplexer to which a command (CMD) interface for issuing a command to the selected external memory and a data (DAT) interface capable of reading/writing stored data are connected.

### PRIORITY

This application claims the benefit under 35 U.S.C. §119(a) of a Korean patent application filed in the Korean Intellectual Property Office on Apr. 20, 2010 and assigned Serial No. 10-2010-0036293, the entire disclosure of which is hereby incorporated by reference.

### BACKGROUND OF THE INVENTION

1. Field of the Invention

The present invention relates to an apparatus and method for recognizing an external memory of a portable terminal. More particularly, the present invention relates to an apparatus and method for performing a memory switching process in a portable terminal that supports a plurality of external memories.

2. Description of the Related Art

The use of portable terminals is rapidly increasing due to their portability, and service providers (terminal manufacturers) are competitively developing mobile terminals with convenient functions in order to attract more users. For example, portable terminals provide various functions, such as a phone book, a game, a scheduler, a Short Message Service (SMS), a Multimedia Message Service (SMS), a Broadcast Message Service (BMS), an Internet service, an Electronic (E) mail service, a wake-up call, a Motion Picture Expert Group (MPEG)-1 or MPEG-2 Audio Layer-3 (MP3) player, a digital camera, and other similar products and services.

Previous portable terminals were usually equipped with memories having a capacity of about 1 MByte for, whereas recent portable terminals are distributed as a digital device and are equipped with high-capacity memories to support high-capacity multimedia data.

However, there is a limitation in that high-capacity internal memories are mounted in portable terminals that are being miniaturized and lightened. As stored data increases according to user demands, more users are noticing the limited capacity of the internal memories.

In order to address this issue, high-capacity external memories have emerged, and users may store desired data without worry about shortage of memory space.

However, even though portable memories can support a plurality of external memories, portable terminals typically include only one slot, and accordingly support only one external memory due their small size. As a result, a user of portable terminals has to attach and detach various external memories to/from a memory slot according to the needs of the user.

Accordingly, in order to address this issue, an apparatus and method for supporting a plurality of external memories in a portable terminal are desired.

### SUMMARY OF THE INVENTION

Aspects of the present invention are to address at least the above problems and/or disadvantages and to provide at least the advantages described below. Accordingly, an aspect of the present invention is to provide an apparatus and method for supporting a plurality of external memories in a portable terminal.

Another aspect of the present invention is to provide an apparatus and method for continuously replaying files stored in a plurality of memories in a portable terminal.

Another aspect of the present invention is to provide an apparatus and method for performing a memory switching process in a portable terminal by delivering a control signal to a multiplexer through a General Purpose Input/Output (GPIO).

In accordance with an aspect of the present invention, an apparatus for supporting a plurality of external memories in a portable terminal is provided. The apparatus includes a control unit for creating a list of data items stored in two or more external memories and for determining an external memory storing next data to reproduce during the reproduction of data included in the list, and a memory extension unit for switching to the external memory storing the next data to reproduce when the next data to reproduce is not stored in the external memory storing data that is currently reproduced.

In accordance with another aspect of the present invention, a method for supporting a plurality of external memories in a portable terminal is provided. The method includes creating a list of data items stored in two or more external memories, determining an external memory storing next data to reproduce during the reproduction of data included in the list, and switching to the external memory storing the next data to reproduce when the next data to reproduce is not stored in the external memory storing data that is currently reproduced.

In accordance with another aspect of the present invention, an apparatus for supporting a plurality of external memories is provided. The apparatus includes a first memory mounted in a first memory slot, a second memory mounted in a second memory slot, a control unit for creating a list of data items stored in at least one of the external memories and for outputting a command for selecting one of the external memories, and a switching unit for determining and selecting one of the external memories storing next data to reproduce during the reproduction of data included in the list, wherein the switching unit includes a multiplexer to which a command (CMD) interface for issuing a command to the selected external memory and a data (DAT) interface capable of reading/writing stored data are connected.

In accordance with another aspect of the present invention, a portable terminal is provided. The portable terminal includes a plurality of memory slots, each memory slot accommodating one of a plurality of external memories, a controller for generating a list of data items stored in the plurality of external memories, a switching unit for selecting an external memory storing next data to be reproduced based on the list of data, the switching unit including a first multiplexer and a second multiplexer connected to a CMD interface for issuing a command to the memory and a DAT interface for reading/writing stored data.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a block diagram of a portable terminal supporting a plurality of memories according to an exemplary embodiment of the present invention;

FIG. 2 is a block diagram of a memory extension unit according to an exemplary embodiment of the present invention;

FIG. 3 is a flow diagram illustrating a process of controlling an external memory card in a portable terminal supporting a plurality of external memories according to an exemplary embodiment of the present invention; and

FIG. 4 is a flow diagram illustrating a memory switching process of a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for continuously reproducing (accessing) files stored in a plurality of memories through a memory switching process in a portable terminal.

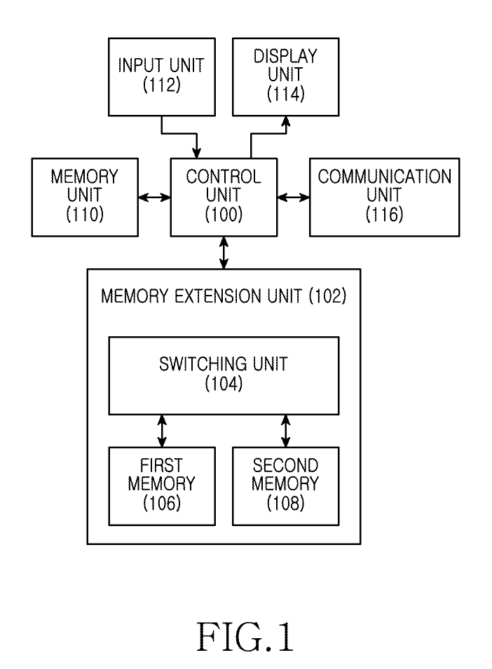

FIGS. 1 through 4, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram of a portable terminal supporting a plurality of memories according to an exemplary embodiment of the present invention.

Referring to FIG. 1, the portable terminal may include a control unit 100, a memory extension unit 102, a memory unit 110, an input unit 112, a display unit 114, and a communication unit 116. The memory extension unit 102 may include a switching unit 104, a first memory 106, and a second memory 108. The portable terminal may include additional units that are not illustrated here merely for sake of clarity. Similarly, the functionality of two or more of the above units may be integrated into a single component.

The control unit 100 controls an overall operation of the portable terminal. For example, the control unit 100 processes and controls voice communication and data communication. In addition to these general functions, the control unit 100 performs a memory switching process in the portable terminal supporting a plurality of external memories to provide the same effect as if one large-capacity memory were used.

For example, the control unit 100 creates a list of data stored in the external memories, and then performs a memory switching process when accessing corresponding data. In this case, clock and power terminals are always connected to a memory slot in which the external memory is mounted, allowing an initialization process for memory selection not to be performed.

The control unit 100 outputs a command for memory switching to the memory extension unit 102 using a General Purpose Input/Output (GPIO) upon memory switching, allowing the memory extension unit 102 to perform the memory switching process.

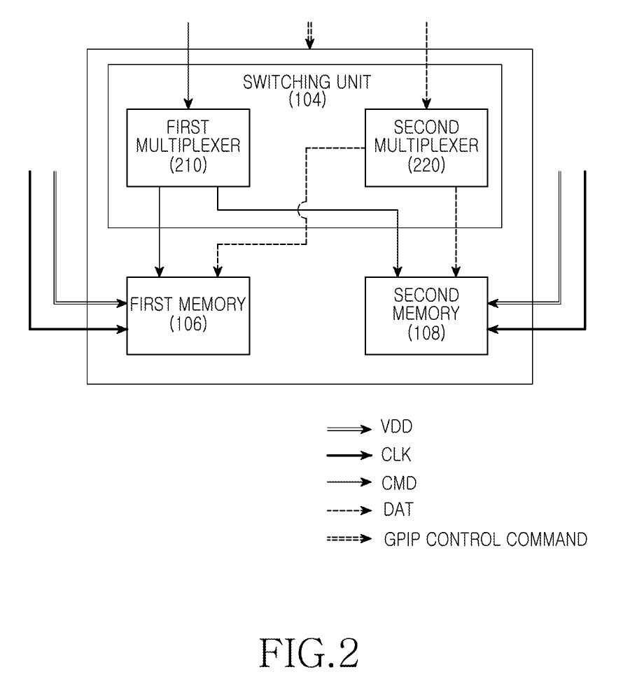

The memory extension unit 102 determines an external memory storing data to access by receiving the control of the control unit 100, and performs a switching process of selecting the determined external memory. When the memory extension unit 102 receives the command of the control unit 100 using a GPIO, the memory extension unit 102 controls the switching unit 104 to allow a multiplexer to be connected to the external memory storing data to access. The operations of the memory extension unit 102 will be described below in detail with reference to FIG. 2.

The switching unit 104 receives the control of the memory extension unit 102 to select an external memory that the portable terminal intends to access. The first memory 106 and the second memory 108 store a large amount of data in the independent external memories, respectively.

The memory unit 110 may include a Read Only Memory (ROM), a Random Access Memory (RAM), a flash ROM, or other similar storage devices. The ROM stores various reference data and microcodes of a program for the process and control of the control unit 100 and the memory extension unit 102.

The RAM is a working memory of the control unit 100, which stores temporary data that are generated during the execution of various programs. The flash ROM stores various data, such as a phone book, outgoing messages, incoming messages, and the like.

The input unit 112 includes numeric keys of digits 0-9 and a plurality of function keys, such as a Menu key, a Cancel (Delete) key, a Confirmation key, a Talk key, an End key, an Internet connection key, Navigation keys (or Direction keys), character input keys, and other similar input keys and buttons. The input unit 112 provides the control unit 100 with key input data that corresponds to a key pressed by a user.

The display unit 114 displays state information, a restricted number of characters, and a large amount of video and still images that are generated during the operation of the portable terminal. The display unit 114 may be a color Liquid Crystal Display (LCD), an Active Mode Organic Light Emitting Diode (AMOLED) display, and other similar display apparatuses. If the display unit 114 has a touch input device and is applied to a touch input type portable terminal, it can be used as the input unit 112.

The communication unit 116 transmits/receives Radio Frequency (RF) signals inputted/outputted through an antenna (not illustrated). For example, in a transmitting (TX) mode, the communication unit 116 channel-encodes, spreads, and RF-processes TX data prior to transmission. In a receiving (RX) mode, the communication unit 116 converts a received RF signal into a baseband signal, and despreads and channel-decodes the baseband signal to restore the original data.

The control unit 100 may be configured to perform the function of the input managing unit 102. Although separate units are provided for respective functions of the control unit 100, the control unit 100 may be configured to perform all or some of the functions on behalf of such separate units.

FIG. 2 is a block diagram of the memory extension unit 102 according to an exemplary embodiment of the present invention.

Referring to FIG. 2, the memory extension unit 102, as described above, includes a switching unit 104, a first memory 106, and a second memory 108. The switching unit 104 includes a first multiplexer 210 and a second multiplexer 220.

A portable terminal uses a command (CMD) signal to be delivered to a memory for recognition of the memory, a clock (CLK) signal for synchronous transfer, a data (DAT) signal for reading/writing of data, and a power source signal VDD. The terms CMD, CLK, DAT, and VDD may refer not only to the signals but also to the paths or interfaces through which those signals travel in the portable terminal. According to an exemplary embodiment of the present invention, the VDD interface and the CLK interface are always connected to a slot in which each external memory is mounted. Only the CMD interface and the DAT interface are connected to a memory slot to be recognized using a multiplexer to perform a memory switching process.

In order to perform the memory switching process, the portable terminal provides a command for performing the memory switching process to the switching unit 104, using a GPIO. The switching unit 104 that has received the command delivers a command for selection of a memory to the multiplexers connected to the respective memory slots.

A CMD signal to be delivered to the memory and a DAT interface for reading/writing of stored data are connected to the multiplexers. The first multiplexer 210 is connected to the CMD interface, and the second multiplexer 220 is connected to the DAT interface. The multiplexers output signals for selecting corresponding external memories under the control of the switching unit 104.

For example, the first multiplexer 210 connected to the first memory 106 is connected to the CMD interface to switch the CMD signal to the first memory 106 or the second memory 108. The second multiplexer 220 connected to the second memory 108 is connected to the DAT interface to switch the DAT signal to the first memory 106 or the second memory 108.

When the portable terminal selects the first memory 106, the first memory 106 may be selected by allowing the first multiplexer 210 to switch the CMD signal to the first memory 106 and allowing the second multiplexer 220 to switch the DAT signal to the first memory 106. On the other hand, when the portable terminal selects the second memory 108, the second memory 108 may be selected by allowing the first multiplexer 210 to switch the CMD signal to the second memory 108 and allowing the second multiplexer 220 to switch the DAT signal to the second memory 108.

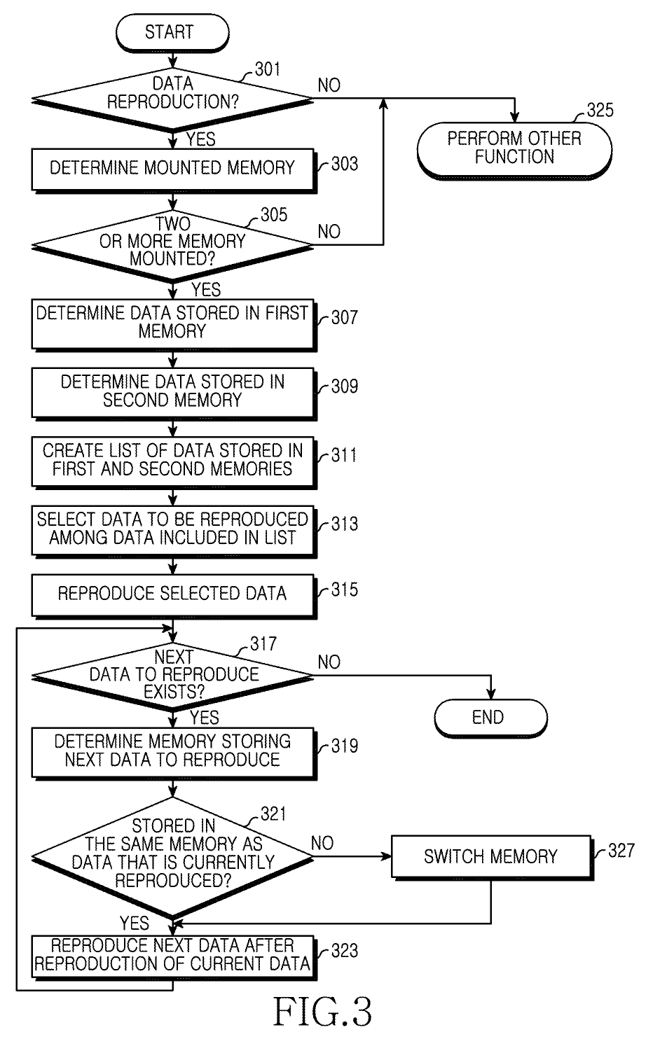

FIG. 3 is a flow diagram illustrating a process of controlling an external memory card in a portable terminal supporting a plurality of external memories according to an exemplary embodiment of the present invention.

Referring to FIG. 3, in step 301, the portable terminal determines whether a data reproduction (access) event occurs. The data reproduction event refers to an event for continuously reproducing data stored in different memories.

If it is determined that a data reproduction event does not occur in step 301, the portable terminal performs other functions in step 325 (e.g., an idle mode).

On the other hand, if it is determined that the data reproduction event occurs in step 301, the portable terminal determines a mounted external memory in step 303. In step 305, the portable terminal determines whether two or more memories are mounted on the portable terminal.

If the number of mounted memories is less than two in step 305, the portable terminal performs other functions in step 325. When the portable terminal verifies that one external memory is mounted, the portable terminal reproduces data stored in the memory, or when no external memory is mounted, the portable terminal may reproduce data stored in an internal memory.

If two or more memories are mounted in step 305, the portable terminal determines data stored in the first memory in step 307. In step 309, the portable terminal determines data stored in the second memory.

Assuming that two external memories are mounted, the portable terminal verifies data stored in the first and second memories. If three external memories are mounted on the portable terminal, the portable terminal may additionally perform a process for verifying data stored in the third memory, and perform similar processes for additional memories.

In step 311, the portable terminal creates a list containing items of data that are determined in steps 307 to 309. In step 313, the portable terminal selects data that are to be reproduced among data contained in the list.

In step 315, the portable terminal reproduces the data selected in step 313. In step 317, the portable terminal determines whether there is more data to reproduce after data that is currently reproduced.

If there is more data to reproduce in step 317, the portable terminal determines a memory storing the next data to reproduce in step 319. In step 321, the portable terminal determines whether the next data is stored in the same memory as the data that is currently reproduced.

If the two data are stored in the same memory in step 321, the portable terminal reproduces next data after the current data is reproduced.

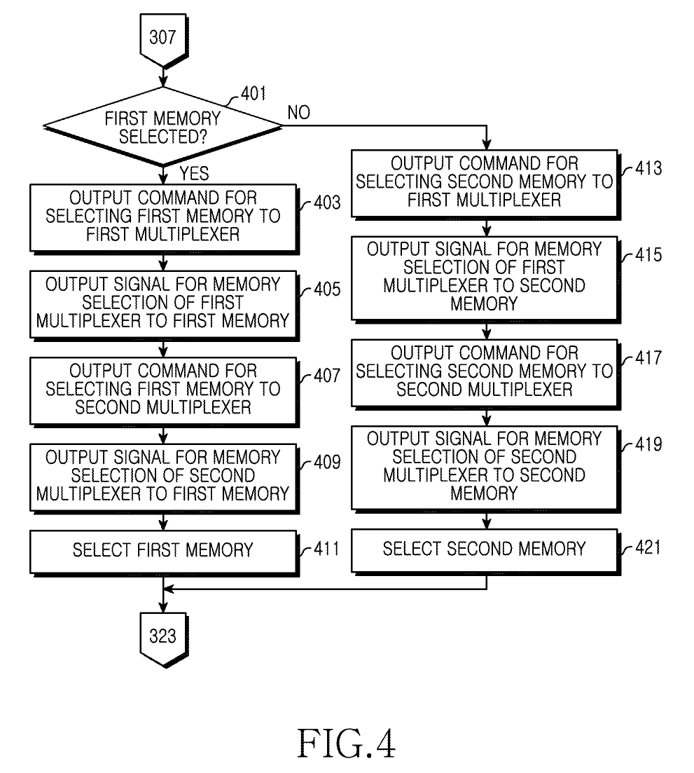

On the other hand, if the two data are stored in different memories in step 321, the portable terminal switches a memory in step 327. Thereafter, in step 323, the portable terminal determines a memory in which next data to be reproduced after the reproduction of the current data exists and reproduces the next data. The process of switching the memory will be described below in detail with reference to FIG. 4.

Thereafter, the portable terminal returns to step 317 to determine whether there is next data to reproduce. After performing the data reproduction and memory switching process until there is no next data to reproduce, the portable terminal ends this algorithm.

FIG. 4 is a flow diagram illustrating a memory switching process of a portable terminal according to an exemplary embodiment of the present invention.

Referring to FIG. 4, in step 401, a portable terminal selects a memory to switch to perform a memory switching process. The portable terminal determines the memory in which next data to reproduce exists, in step 401 like that in FIG. 3.

If it is determined that a first memory is selected in step 401, i.e., if next data to reproduce is stored in the first memory, the portable terminal outputs a command to a first multiplexer 210 connected to the CMD interface in step 403 for selecting the first memory. In step 405, the portable terminal allows the first multiplexer 210 having received the command to output the CMD signal for selecting the first memory to the first memory.

In step 407, the portable terminal outputs a command for selecting the first memory to the second multiplexer 220 connected to DAT interface. In step 409, the portable terminal allows the second multiplexer 220 having received the command to output the DAT signal for selecting the first memory to the first memory.

A portable terminal uses a CMD signal to be delivered to a memory for recognition of the memory, a CLK signal for synchronous transfer, a DAT signal for reading/writing of data, and a VDD signal for a power source. According to an exemplary embodiment of the present invention, the VDD interface and the CLK interface are always connected to a slot in which each external memory is mounted. Only the CMD interface and the DAT interface are connected to a memory slot to be recognized using a multiplexer to perform a memory switching process.

For example, the portable terminal may connect the first memory to the CMD interface through the first multiplexer 210 connected to the CMD interface in order to the first memory, and may connect the DAT interface to the first memory through the second multiplexer 220 connected to the DAT interface. Thereafter, the portable terminal selects the first memory in step 411.

On the other hand, if it is determined that the second memory is selected in step 401, i.e., if next data to reproduce is stored in the second memory, the portable terminal outputs a command to the first multiplexer 210 connected to the CMD interface in step 413 for selecting the second memory. In step 415, the portable terminal allows the first multiplexer having received the command to output the DAT signal for selecting the second memory to the second memory.

In step 417, the portable terminal outputs a command for selecting the second memory to the second multiplexer 220 connected to the DAT interface. In step 419, the portable terminal allows the second multiplexer 220 having received the command to output the DAT signal for selecting the second memory to the second memory.

In step 421, the portable terminal selects the second memory. As described above, the portable terminal having performed the memory switching process performs the process of step 323 of FIG. 3.

As described above, a portable terminal according to an exemplary embodiment of the present invention transmits a control signal for switching a memory to a multiplexer through GPIO. Accordingly, it is possible to switch to a memory storing next data to reproduce, thereby securing a storage capacity larger than that of a typical portable terminal supporting only one external memory.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for supporting a plurality of external memories in a portable terminal, the apparatus comprising:
a control unit for creating a list of data items stored in two or more external memories and for determining an external memory storing next data to reproduce during a reproduction of data included in the list; and
a memory extension unit for switching to the external memory storing the next data to reproduce when the next data to reproduce is not stored in the external memory storing data that is currently reproduced.

2. The apparatus of claim 1, wherein the apparatus continuously supplies a power source and a clock signal to a memory slot in which the external memories are mounted.

3. The apparatus of claim 1, wherein the memory extension unit outputs a command for selecting the external memory storing the next data to reproduce to multiplexers connected to external memory slots, and allows the multiplexers having received the command to output a signal for memory selection to a corresponding external memory.

4. The apparatus of claim 3, wherein the multiplexer comprises a first multiplexer and a second multiplexer, and the memory extension unit allows the first multiplexer to connect a command (CMD) interface for commanding to the memory to the external memory, and allows the second multiplexer to connect a data (DAT) interface for controlling reading/writing of stored data to the external memory.

5. The apparatus of claim 3, wherein the memory extension unit outputs a command for selecting an external memory storing the next data to reproduce to the multiplexers connected to the external memory slots using a General Purpose Input/Output (GPIO).

6. A method for supporting a plurality of external memories in a portable terminal, the method comprising:
creating a list of data items stored in two or more external memories;
determining an external memory storing next data to reproduce during the reproduction of data included in the list; and
switching to the external memory storing the next data to reproduce when the next data to reproduce is not stored in the external memory storing data that is currently reproduced.

7. The method of claim 6, further comprising continuously supplying a power and a clock signal to a memory slot mounted with the external memories.

8. The method of claim 6, wherein the switching to the external memory storing the next data to reproduce comprises:
outputting a command for selecting the external memory storing the next data to reproduce to multiplexers connected to external memory slots; and
outputting, by the multiplexers receiving the command, a signal for selection of a memory to a corresponding external memory.

9. The method of claim 8, wherein the outputting of the signal by the multiplexers receiving the command comprises:
dividing the multiplexers into a first multiplexer and a second multiplexer;
connecting, by the first multiplexer, a command (CMD) interface issuing a command to the external memory; and
connecting, by the second multiplexer, a data (DAT) interface controlling read/writing of stored data to the external memory.

10. The method of claim 8, wherein the outputting of the command comprises outputting the command to the multiplexer using a general purpose input/output.

11. An apparatus for supporting a plurality of external memories, the apparatus comprising:
a first memory mounted in a first memory slot;
a second memory mounted in a second memory slot;
a control unit for creating a list of data items stored in at least one of the external memories and for outputting a command for selecting one of the external memories; and
a switching unit for determining and selecting one of the external memories storing next data to reproduce during the reproduction of data included in the list,
wherein the switching unit comprises a multiplexer to which a command (CMD) interface for issuing a command to the selected external memory and a data (DAT) interface for reading/writing stored data are connected.

12. The apparatus of claim 11, wherein the control unit continuously supplies a power and a clock signal to the first and second memory slots.

13. The apparatus of claim 11, wherein the switching unit outputs a command for selecting the external memory storing the next data to reproduce to the multiplexers, and allows the multiplexers having received the command to output a signal for memory selection to a corresponding external memory.

14. The apparatus of claim 11, wherein the control unit outputs the command for selecting the external memory to the switching unit using a general purpose input/output.

15. A portable terminal comprising:
a plurality of memory slots, each memory slot accommodating one of a plurality of external memories;
a controller for generating a list of data items stored in the plurality of external memories;
a switching unit for selecting an external memory storing next data to be reproduced based on the list of data, the switching unit including a first multiplexer and a second multiplexer connected to a command (CMD) interface for issuing a command to the memory and a data (DAT) interface for reading/writing stored data.
